(19) United States
(12) Patent Application Publication
(10) Pub. No.: US 2013/0176368 A1
(43) Pub. Date: Jul. 11, 2013

(54) INK-JET INKS HAVING IMPROVED CORROSION RESISTANCE

(71) Applicant: JAMES WALTER WHEELER, WEST CHESTER, PA (US)

(72) Inventor: JAMES WALTER WHEELER, WEST CHESTER, PA (US)

(73) Assignee: E I DU PONT DE NEMOURS AND COMPANY, Wilmington, DE (US)

(21) Appl. No.: 13/545,380

(22) Filed: Jul. 10, 2012

Related U.S. Application Data
(60) Provisional application No. 61/506,686, filed on Jul. 12, 2011.

(51) Int. Cl. C09D 11/00

(52) U.S. Cl. CPC C09D 11/38
USPC 347/100; 524/429

(57) ABSTRACT

The present disclosure pertains to an aqueous ink jetink having improved corrosion resistance. Nitrate and nitrite salts were found to be effective anti-corrosion agent for ink-jet inks especially when an ink-jet printer cartridge contains metal such as aluminum or aluminum alloy that comes into contact with the ink-jet ink.

### CROSS-REFERENCE TO RELATED APPLICATION

This application claims priority under 35 U.S.C. §119 from U.S. Provisional Application Ser. No. 61/506,686, filed Jul. 12, 2011.

### BACKGROUND OF THE DISCLOSURE

The present disclosure pertains to ink-jet inks, and in particular to aqueous ink-jet inks having improved corrosion resistance. The disclosure further relates to the use of ink-jet inks having improved corrosion resistance, and in particular the use of these inks in ink-jet print cartridges comprising metal or metal alloys.

Ink jet printing is a non-impact printing process in which droplets of ink are deposited on a substrate, such as paper, to form the desired image. The droplets are ejected from a print head in response to electrical signals generated by a microprocessor. Ink-jet printers offer low cost, high quality printing and have become a popular alternative to other types of printers.

An ink-jet ink is characterized by a number of necessary properties, including color, jettability, decap time (latency), drying time and shelf-life, among others. There is, however, often a tradeoff between these properties because improving one property can result in the deterioration of another property.

Both soluble (dye) and insoluble (pigment) colorants have been used in ink-jet inks. Pigments are advantageous because they tend to provide more water-fast and light-fast images than dye inks. Because a pigment is typically not soluble in an aqueous vehicle, it is often required to use a dispersing agent, such as a polymeric dispersant or a surfactant, to produce a stable dispersion of the pigment in an ink vehicle. Often the pigment in an ink is stabilized by a dispersant via ionic interactions.

The ink-jet inks may be used in ink-jet recording apparatuses several types of which include ink-jet print cartridges provided with ink flow passages formed of metal such as aluminum or aluminum alloys. When the inks used therein are aqueous ink-jet inks, the metal may be corroded with long term contact. The metallic ions thus released into the inks can precipitate ionically stabilized dispersions leading to printing problems such as clogging of print head nozzles, deterioration in the accuracy of discharge and landing of ink droplets, etc.

U.S. Pat. No. 5,102,458 discloses using secondary amines to inhibit corrosion of metal placed in contact with ink-jet inks.

A need exists for ink jetinks having improved corrosion resistance without impacting ink performance when used in print cartridges comprising metal such as aluminum or aluminum alloys. The present disclosure satisfies this need by providing ink jetink compositions having improved corrosion resistance.

### SUMMARY OF THE DISCLOSURE

An embodiment provides an aqueous ink jetink having improved corrosion resistance comprising an aqueous vehicle, a colorant, a polymeric dispersant and an anti-corrosion agent, wherein said anti-corrosion agent is a nitrate or a nitrite salt, or a combination thereof.

Another embodiment provides that the ink jetink further comprises a polymeric binder.

Another embodiment provides that the anti-corrosion agent is a nitrate salt.

Another embodiment provides that the nitrate salt is selected from the group consisting of sodium nitrate, potassium nitrate, lithium nitrate, and mixtures thereof.

Another embodiment provides that the colorant is a dye.

Another embodiment provides that the anti-corrosion agent is present at a concentration of greater than 500 ppm.

Another embodiment provides that the anti-corrosion agent is present at a concentration of greater than 1000 ppm.

Another embodiment provides a method for controlling corrosion in an ink jet printing process, the method comprising applying an ink-jet ink composition to a substrate, wherein said ink-jet ink composition comprises an aqueous vehicle, a colorant, a polymeric dispersant and an anti-corrosion agent, wherein said anti-corrosion agent is a nitrate or a nitrite salt, or a combination thereof.

Another embodiment provides aqueous ink-jet ink and an ink-jet printer cartridge combination, wherein said ink jetink comprises an aqueous vehicle, a colorant, a polymeric dispersant and an anti-corrosion agent, wherein said anti-corrosion agent is a nitrate or a nitrite salt, or a combination thereof, and wherein said printer cartridge comprises an ink flow passage, and said ink flow passage comprises at least one elemental metal or alloy.

Another embodiment provides that the elemental metal is aluminum.

Yet another embodiment provides that the alloy contains aluminum and iron.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, almost all.

As used herein, the term “dyne/cm” means dyne per centimetre, a surface tension unit.

As used herein, the term “cP” means centipoise, a viscosity unit.

As used herein, the term “mPa·s” means millipascal second, a viscosity unit.

As used herein, the term “mN·m⁻¹” means milliNewtons per meter, a surface tension unit.

As used herein, the term “mS·cm⁻¹” means milliSiemens per centimeter, a conductivity unit.

As used herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid).

As used herein, the term “NTA” means nitrilotriacetic acid.

As used herein, the term “DHEG” means dihydroxyethylglycine.

As used herein, the term “CyDTA” means trans-1,2-cyclohexanediaminetetraacetic acid.

As used herein, the term “DTPA” means diethylenetriamine-N,N,N′,N″,N″-pentaacetic acid.

As used herein, the term “GEDTA” means glycoletherdiamine-N,N,N′,N′-tetraacetic acid.

As used herein, Surfynol® 440 is a surfactant from Air Products (Allentown, Pa., U.S.A.).

As used herein, Surfynol® 61 is a surfactant and also an anti-corrosion agent from Air Products (Allentown, Pa., U.S.A.).

As used herein, the term “jettability” means good jetting properties with no clogging or deflection during printing.

Unless otherwise noted, the above chemicals were obtained from Aldrich (Milwaukee, Wis., U.S.A.) or other similar suppliers of laboratory chemicals.

The materials, methods, and examples herein are illustrative only except as explicitly stated, and are not intended to be limiting.

In addition, references in the singular may also include the plural (for example, “a” and “an” may refer to one, or one or more) unless the context specifically states otherwise.

### Aqueous Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present disclosure are those that are disclosed in U.S. Pat. No. 5,085,698.

If a mixture of water and a water-soluble solvent is used, the aqueous vehicle typically will contain about 30% to about 95% of water with the remaining balance (i.e., about 70% to about 5%) being the water-soluble solvent. Compositions of the present disclosure may contain about 40% to about 95% water, based on the total weight of the aqueous vehicle.

The amount of aqueous vehicle in the ink is typically in the range of about 70% to about 99.8%; specifically about 80% to about 99.8%, based on total weight of the ink.

The aqueous vehicle can be made to be fast penetrating (rapid drying) by including surfactants or penetrating agents such as glycol ether(s) or 1,2-alkanediols. Suitable surfactants include ethoxylated acetylene diols (e.g., Surfynols® series from Air Products), ethoxylated primary (e.g., Neodol® series from Shell) and secondary (e.g., Tergitol® series from Union Carbide) alcohols, sulfosuccinates (e.g., Aerosol® series from Cytec), organosilicones (e.g., Silwet® series from Witco) and fluoro surfactants (e.g., Zonyl® series from DuPont).

The amount of glycol ether(s) or 1,2-alkanediol(s) added must be properly determined, but is typically in a range of from about 1% to about 15% by weight, and more typically about 2% to about 10% by weight, based on the total weight of the ink. Surfactants may be used, typically in an amount of from about 0.01% to about 5%, and specifically from about 0.2% to about 2%, based on the total weight of the ink.

### Colorants

The term “pigment” as used herein means an insoluble colorant that requires to be dispersed with a dispersant and processed under dispersive conditions in the presence of a dispersant. The colorant also includes dispersed dyes. The dispersion process results in a stable dispersed pigment.

The selected pigment(s) may be used in dry or wet form. For example, pigments are usually manufactured in aqueous media, and the resulting pigments are obtained as a water-wet presscake. In presscake form, the pigment does not agglomerate to the extent like it is in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in ink-jet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; white pigments such as TiO₂ and ZnO; and black pigment carbon black.

Some examples of dispersed dyes suitable for the present disclosure include: black inks from the combination of DB291:1, D029 and DR 177; cyan dyes such as DB27, DB60, DB73, DB77, DB77:1, DB87, DB257, DB367 and mixtures thereof; magenta dyes such as DRS, DR75, DR76, DR86, DR91, DR92, DR121, DR127, DR132, DR145, DR159, DR164, DR179, DR184, DR189, DR191 and mixtures thereof; yellow dyes such as DY5, DY27, DY33, DY42, DY50, DY59, DY79, DY83, DY98, DY100, DY114, DY122, DY139, DY140, DY160, DY199, DY201, DY204, DY206, DY224, DY231 and mixtures thereof; red dyes such as DR177, DR229, DR258 and mixtures thereof; and violet dyes such as DV37, DV57, DV63, DV99 and mixtures thereof.

The names and abbreviations used herein for pigments and dyes are the “C.I.” designation for pigments established by Society of Dyers and Colourists, Bradford, Yorkshire, UK and published in The Color Index, Third Edition, 1971.

### Polymeric Dispersant

A polymeric dispersant is employed to disperse pigment or dye to form an aqueous dispersion. The polymeric dispersant may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117.

Stabilization of colorant dispersions generally involves using either a non-ionic or an ionic polymer. Non-ionic polymer typically has a non-ionic hydrophilic section that extends into the water medium. The hydrophilic section provides entropic or steric stabilization that stabilizes the pigment particles in the aqueous vehicle. Polyvinyl alcohol, cellulosics, ethylene oxide modified phenols and ethylene oxide/propylene oxide polymers may be used for this purpose. While the use of non-ionic polymer is not sensitive to pH changes or ionic contamination, it has a major disadvantage in that the printed image is often water sensitive.

When an ionic polymer is used as a dispersant, the pigment particles are stabilized by ion-containing monomers, such as neutralized acrylic, maleic or vinyl sulfonic acid. The polymer provides stabilization through a charged double layer mechanism whereby ionic repulsion hinders the particles from flocculation. Since the neutralizing component tends to evaporate after printing, the remaining polymer has reduced water solubility resulting in the printed image being not water sensitive.

Both non-ionic and ionic polymer can be used as dispersant in the present disclosure while ionic polymer is most suitable for the present disclosure.

### Anti-Corrosion Agent

The inventor finds that the presence of nitrate and nitrite salts in an ink-jet ink can prevent the corrosion of metal parts that come into contact with the ink.

Typically, the nitrate and nitrite salts are salts of monovalent metal. More typically the nitrate salts are sodium nitrate, potassium nitrate, lithium nitrate, or mixtures thereof; and the nitrite salts are sodium nitrite, potassium nitrite, lithium nitrite, or mixture thereof. Most typically, the nitrate salt is sodium nitrate and the nitrite salt is sodium nitrite.

The anti-corrosion agent is included in the ink in an effective amount to control corrosion relative to the same ink without the anti-corrosion agent. In one embodiment, the anti-corrosion agent is present in an ink at a level of greater than 500 ppm. In another embodiment, the anti-corrosion agent is present at a level of greater than 1000 ppm. The upper level is not limited, but is dictated by considerations such as compatibility with other ink components. The appropriate levels of anti-corrosion agent can be readily determined by one of ordinary skill in the art through routine experimentation.

### Ink-Jet Printer Cartridge

The inks of the present disclosure may be printed with any suitable ink-jet printer comprising an ink-jet printer cartridge, typically having one or more ink-jet ink flow channels or passages, at least a portion of which is formed of an aluminum-containing metal.

The aluminum-containing metal may be aluminum alone or an alloy containing aluminum and a metal other than aluminum (an aluminum alloy). Examples of other metals include iron, chromium, molybdenum, copper, nickel, titanium, niobium, tantalum, cobalt, tungsten silicon, nitrogen, sulfur, manganese, etc. In the aluminum-containing alloy, the aluminum content is not particularly limited. The aluminum content, for example, may be in the range of 1 to 99.5% by weight. In a typical example, the aluminum content is in the range of 10 to 70% by weight. The aluminum-containing alloy may be, for example, an alloy containing aluminum and iron (an aluminum-iron alloy). The aluminum alloy may contain components other than metals, such as carbon, as well.

The ink jetprinter cartridge used herein is not particularly limited and can be the same as those conventionally employed in ink jetprinters. For instance, the ink-jet printer cartridge may comprise a print head and an ink tank for supplying ink to the print head configured, for example, as shown in U.S. Pat. No. 6,957,882. The ink tank typically includes one or more ink chambers, and the ink chambers are connected to the print head via one or more ink flow channels or passages. The printer cartridges are typically filled with, for example, four colors of ink, of cyan, magenta, yellow, and black. The printer cartridge may be detachably installed in a printer. The ink ejecting method that is employed for the ink jetprint head is not limited herein, with piezoelectric element methods, thermal bubble-jet methods, and electrostatic attraction methods being some of the more conventional possibilities.

### Polymeric Binder

Polymers may be added to the ink to improve durability or other properties. The polymers can be soluble in the vehicle or in a dispersed form, and can be ionic or nonionic. Soluble polymers include linear homopolymers and copolymers or block polymers. They also can be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. They may be made by a solution, emulsion, or suspension polymerization process. Typical classes of polymer additives include anionic acrylic, styrene-acrylic and polyurethane polymer.

When a polymer is present, its level is typically between about 0.01% and about 10% by weight, based on the total weight of an ink. The upper limit is dictated by ink viscosity or other physical limitations.

### Other Additives

Other ingredients, additives, may be formulated into the ink-jet ink, to the extent that such other ingredients do not interfere with the stability and jettability of the ink-jet ink. This may be readily determined by routine experimentation by one skilled in the art.

Surfactants are commonly added to inks to adjust surface tension and wetting properties. Suitable surfactants include the ones disclosed in the Vehicle section above. Surfactants are typically used in amounts up to about 5% and more typically in amounts up to 2% by weight, based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

### Ink Sets

The term “ink set” refers to all the individual inks or other fluids an ink jet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

The inventive ink is suitable for low viscosity applications such as those required by thermal print heads. Thus the viscosity of the inventive inks at 25° C. can be less than about 7 cP, typically less than about 5 cP, and more typically less than about 3.5 cP. Thermal ink jetactuators rely on instantaneous heating/bubble formation to eject ink drops and this mechanism of drop formation generally requires inks of lower viscosity.

The inventive ink is also suitable for high viscosity applications such as those required by piezo print heads. Thus the viscosity of the inventive inks at 25° C. can be less than about 30 cP, typically less than about 25 cP, and more typically less than about 20 cP.

### Substrate

The present embodiments are particularly advantageous for printing on polyester fabrics. The present embodiments are also suitable for printing on plain paper, such as common electrophotographic copier paper and photo paper, glossy paper and similar papers used in ink-jet printers.

The following examples illustrate the disclosure without, however, being limited thereto.

### EXAMPLES

### Testing of Anti-Corrosion Property

The efficacy of an anti-corrosion agent in an ink was evaluated by dipping two aluminum wires into 50 g of the ink to a depth of 4 cm. A 2.0 voltage of direct current potential was applied to the wires for two hours. The anode wire was then rinsed with water, visually inspected, dried in an oven at 150 C. for 1 hour, and weighed to determine the weight of the precipitate on the wire. A low amount of precipitate on the anode wire means less corrosion, since less metallic ions were released from the cathode into the ink.

### Polyurethane Binder

Black inks similar to the ones described in the examples of U.S. Pat. No. 7,211,130 from the combination of dispersed dyes were prepared according to the ingredients listed in Table 1 below. The polyurethane binder is Polyurethane Dispersoid 1 (PUD EX 1) described in U.S. Patent Publication No. 20050215663.

TABLE 1

| Ingredients | Weight % |
|---|---|
| Ethylene glycol | 18 |
| Glycerol | 26 |
| Surfynol ® 440 | 1.25 |
| Polyurethane binder | 8 |
| DB291:1 | 3.4 |
| DR177 | 1.8 |
| DO29 | 1.4 |
| Anti-Corrosion Agent | As listed in Table 2 below |
| De-ionized Water | Balance to 100% |

As shown in Table 2 below, Ink 1 is an inventive ink containing sodium nitrate as the anti-corrosion agent. Ink 1-A is a control ink without the presence of any anti-corrosion agent. Inks C-1-C-13 are comparative inks containing various additives known as anti-corrosion agents. These inks were subjected to the corrosion test described above. As summarized in Table 2, Ink 1, containing 0.1% of sodium nitrate in the ink composition, had no visible deposit on the anode and was confirmed by no increase in weight on the anode wire. The control ink, Ink 1-A, showed medium level of deposit on the anode and an increase in weight of 3.8 mg. All comparative inks, Inks C-1-C-13, showed various levels of deposit on the anode and were accompanied by increases in weight on the anode.

TABLE 2

| | Ink | Ink | Ink | Ink | Ink | Ink | Ink | Ink | Ink |
|---|---|---|---|---|---|---|---|---|---|
| | 1 | 1-A | C-1 | C-2 | C-3 | C-4 | C-5 | C-6 | C-7 |
| Anti-Corrosion | | | | | | | | | |
| Agent | | | | | | | | | |
| Sodium nitrate* | 0.1 | — | — | — | — | — | — | — | — |
| None | — | — | — | — | — | — | — | — | — |
| 2-Ethylhexanoic | — | — | 0.2 | — | — | — | — | — | — |
| acid* | | | | | | | | | |
| 1,4-Bis(2- | — | — | — | 0.2 | — | — | — | — | — |
| hydroxyethoxy)- | | | | | | | | | |
| 2-butyne* | | | | | | | | | |
| Benzotriazol* | — | — | — | — | 0.1 | — | — | — | — |
| Dimercapto | — | — | — | — | — | 0.1 | — | — | — |
| thiadiazole* | | | | | | | | | |
| Disodium hydrogen | — | — | — | — | — | — | 0.4 | — | — |
| phosphate* | | | | | | | | | |
| Surfynol ® 61* | — | — | — | — | — | — | — | 0.2 | — |
| Sodium molybdate* | — | — | — | — | — | — | — | — | 0.1 |
| Anti-Corrosion | | | | | | | | | |
| Property | | | | | | | | | |
| Electrode Visual | 0 | 3 | 1 | 1 | 3 | 3 | 3 | 3 | 2 |
| Inspection\hat{ } | | | | | | | | | |
| Weight of Deposits | 0 | 3.8 | 0.1 | 0.1 | 1.4 | 1.1 | 2.7 | 1.4 | 1.1 |
| (mg) | | | | | | | | | |

| | Ink | Ink | Ink | Ink | Ink | Ink |
|---|---|---|---|---|---|---|
| | C-8 | C-9 | C-10 | C-11 | C-12 | C-13 |
| Anti-Corrosion | | | | | | |
| Agent | | | | | | |
| Sebacic acid, | 0.2 | — | — | — | — | — |
| disodium salt* | | | | | | |
| 2-Mercapto | — | 0.1 | — | — | — | — |
| benzothiazole* | | | | | | |
| 5-Methyl-1H- | — | — | 0.1 | — | — | — |
| benzotriazole* | | | | | | |
| Sodium tetraborate | — | — | — | 0.05 | — | — |
| Na2B4O7* | | | | | | |
| Sodium fluoride* | — | — | — | — | 0.003 | — |
| Sodium | — | — | — | — | — | 0.01 |
| fluorophosphate* | | | | | | |
| Anti-Corrosion | | | | | | |
| Property | | | | | | |
| Electrode Visual | 3 | 2 | 3 | 2 | 2 | 3 |
| Inspection\hat{ } | | | | | | |
| Weight of Deposits | 1.7 | 2.3 | 0.6 | 1.1 | 1.9 | 1.1 |
| (mg) | | | | | | |

Note:
*Percent by weight based on total weight of ink
\hat{ }Electrode visual inspection ratings: 0, no deposit; 1, slight deposit; 2, medium deposit; 3, heavy deposit.

1. An aqueous ink-jet ink having improved corrosion resistance comprising an aqueous vehicle, a colorant, a polymeric dispersant and an anti-corrosion agent, wherein said anti-corrosion agent is a nitrate or a nitrite salt, or a combination thereof.

2. The ink of claim 1, further comprises a polymeric binder.

3. The ink of claim 2, wherein said anti-corrosion agent is a nitrate salt.

4. The ink of claim 3, wherein said nitrate salt is selected from the group consisting of sodium nitrate, potassium nitrate, lithium nitrate, and mixtures thereof.

5. The ink of claim 4, wherein said colorant is a dye.

6. The ink of claim 5, wherein said anti-corrosion agent is present at a concentration of greater than 500 ppm.

7. The ink of claim 6, wherein said anti-corrosion agent is present at a concentration of greater than 1000 ppm.

8. The ink of claim 4, wherein said colorant is a pigment.

9. The ink of claim 8, wherein said anti-corrosion agent is present at a concentration of greater than 500 ppm.

10. The ink of claim 9, wherein said anti-corrosion agent is present at a concentration of greater than 1000 ppm.

11. A method for controlling corrosion in an ink jetprinting process, the method comprising applying an ink-jet ink composition to a substrate, wherein said ink-jet ink composition comprises an aqueous vehicle, a colorant, a polymeric dispersant and an anti-corrosion agent, wherein said anti-corrosion agent is a nitrate or a nitrite salt, or a combination thereof.

12. The method of claim 11, wherein said anti-corrosion agent is a nitrate salt.

13. An aqueous ink-jet ink and an ink jetprinter cartridge combination, wherein said ink-jet ink comprises an aqueous vehicle, a colorant, a polymeric dispersant and an anti-corrosion agent, wherein said anti-corrosion agent is a nitrate or a nitrite salt, or a combination thereof, and wherein said printer cartridge comprises an ink flow passage, and said ink flow passage comprises at least one elemental metal or alloy.

14. The ink-jet ink/printer cartridge combination of claim 13, wherein said ink jetink further comprises a polymeric binder.

15. The ink-jet ink/printer cartridge combination of claim 14, wherein said elemental metal is aluminum.

16. The ink ink-jet ink/printer cartridge combination of claim 13, wherein said alloy contains aluminum and iron.

17. The ink-jet ink/printer cartridge combination of claim 13, wherein said anti-corrosion agent is a nitrate salt.

18. The ink-jet ink/printer cartridge combination of claim 17, wherein said nitrate salt is selected from the group consisting of sodium nitrate, potassium nitrate, lithium nitrate, and mixtures thereof.

19. The ink-jet ink/printer cartridge combination of claim 18, wherein said anti-corrosion agent is present at a concentration of greater than 500 ppm.

20. The ink-jet ink/printer cartridge combination of claim 19, wherein said anti-corrosion agent is present at a concentration of greater than 1000 ppm.
